(19) United States
(12) Patent Application Publication
(10) Pub. No.: US 2024/0417030 A1
(43) Pub. Date: Dec. 19, 2024

(54) Method for Controlling an Electric Motor of an Electric Bicycle

(71) Applicant: ZF Friedrichshafen AG, Friedrichshafen (DE)

(72) Inventor: Patrik Rösch, Aulendorf (DE)

(21) Appl. No.: 18/698,504

(22) PCT Filed: Oct. 5, 2022
(86) PCT No.: PCT/EP2022/077685

§ 371 Date: Apr. 4, 2024

(30) Foreign Application Priority Data
Oct. 6, 2021 (DE) 10 2021 211 270.6

(51) Int. Cl. B62M 6/45; H02P 6/08

(52) U.S. Cl. CPC B62M 6/45; H02P 6/08

(57) ABSTRACT

A method for controlling an electric motor of an electric bicycle includes detecting (S1.1) an input torque at at least two different points in time, detecting (S1.2) a cadence of a crank at at least two different points in time, determining (S2.1) a change in the input torque over time on the basis of the detected input torque at at least two different points in time, determining (S2.2) a change in the cadence over time on the basis of the detected cadence at at least two different points in time, determining (S3) a base torque depending on the change in the input torque over time and depending on the change in the cadence over time, and controlling (S6) the electric motor with a target torque depending on the base torque. In the determining (S3), the dependence of the base torque on the change in the input torque over time decreases as the cadence increases, and the dependence of the base torque on the change in the cadence over time increases as the cadence increases

### CROSS-REFERENCE TO RELATED APPLICATIONS

The present application is related and has right of priority to German Patent Application No. DE102021211270.6 filed on Oct. 6, 2021 and is a U.S. National Phase of PCT/EP2022/077685 filed in the European Patent Office on Oct. 5, 2022, both of which are incorporated by reference in their entirety for all purposes.

### TECHNICAL FIELD

The technical field relates generally to a method for controlling an electric motor of an electric bicycle.

### BACKGROUND

Methods are known from the prior art for controlling an electric motor of an electric bicycle, wherein the electric motor is controlled depending on a movement of the crank.

### BRIEF SUMMARY

Example aspects of the invention relate to a method for controlling an electric motor of an electric bicycle. The electric bicycle can have a battery as a stored energy source. The electric motor can have a motor control unit and the motor control unit can be designed to carry out the method for controlling the electric motor. The motor control unit can be designed to control, by the method, a power supply of the electric motor with electrical energy stored in the battery.

The bicycle includes the electric motor and a crank. Via a chainring which is connected to the crank, a rear wheel of the bicycle can be driven via a chain. The electric motor and the crank can be connected such that the electric motor can influence a rotational motion of the crank. The crank can have a pedal at each end of the crank for a foot of a rider of the bicycle. The rider can apply an input torque to the crank via muscle power. The electric motor can apply an additional torque to the crank. A sum of the input torque and the additional torque of the electric motor can drive the rear wheel via the chain.

The method includes detecting the input torque at at least two different points in time. The input torque can be periodically detected and, alternatively or additionally, the input torque can be detected at more than two different points in time. The bicycle can have a sensor, with which the input torque can be detected. The method also includes detecting a cadence of the crank at at least two different points in time. The cadence of the crank can be periodically detected and, alternatively or additionally, the cadence can be detected at more than two different points in time. The bicycle can have a sensor, with which the cadence of the crank can be detected.

The method also includes determining a change in the input torque over time on the basis of the detected input torque at at least two different points in time. The method also includes determining a change in the cadence over time on the basis of the detected cadence at at least two different points in time. Determining the change in the input torque over time and, alternatively or additionally, the change in the cadence over time can be carried out on the basis of all detected input torques and all detected cadences. In the determining, a function of the input torque and, alternatively or additionally, a function of the cadence can be determined as a function of time. In the determining, a function of the change in the input torque over time and, alternatively or additionally, a function of the change in the cadence over time can be determined as a function of time. Alternatively or additionally, in the determining the changes in the input torque and in the cadence over time, a relative change in the detected value of the input torque and of the cadence with respect to the previous detected value can be determined.

The method also includes determining a base torque depending on the change in the input torque over time and depending on the change in the cadence over time. The determining the base torque can be carried out iteratively, wherein, for an nth step of determining the base torque, the base torque from the n-1 step of determining the base torque can be used. In other words, the determining the base torque can therefore also represent filtering the base torque from preceding determining the base torque. The step of determining the base torque can be carried out depending on the input torque, in particular depending on the absolute value of the input torque. Therefore, in a first step of determining the base torque, the base torque can be assumed to be equal to the input torque and the iteration can be started. The iteration can be minimized by using a dynamic function. Therefore, if the changes in the input torque and the cadence over time have changed, a base torque to be determined can be reached or obtained via filtering more quickly.

In the determining the base torque, the dependence of the base torque on the change in the input torque over time decreases as the cadence increases. The dependence of the base torque on the change in the input torque over time as a function of the cadence can be represented as a monotonically decreasing or strictly monotonically decreasing function. The function can be represented by a linear function, a polynomial function, or an exponential function. In other words, the base torque can depend on the change in the input torque over time more heavily at lower cadences than at higher cadences. The weighting of the change in the input torque can decrease as the cadence increases when determining the base torque.

In the determining the base torque, the dependence of the base torque on the change in the cadence over time increases as the cadence increases. The dependence of the base torque on the change in the cadence over time as a function of the cadence can be represented as a monotonically increasing or strictly monotonically increasing function. The function can be represented by a linear function, a polynomial function, or an exponential function. In other words, the base torque can depend on the change in the cadence over time less heavily at lower cadences than at higher cadences. The weighting of the change in the cadence can increase as the cadence increases when determining the base torque.

A sum of the weightings of the changes in input torque and cadence can be constant. In other words, the weightings can behave inversely with respect to one another. When the weighting with respect to the change in the torque over time is higher at lower cadences, the weighting with respect to the cadence can be lower. Conversely, the weighting with respect to the torque can be lower at higher cadences, and the weighting with respect to the cadence can be higher.

The base torque can be determined on the basis of one or more tables. Therefore, a table can describe the dependence of the base torque on the change in the input torque over time. In columns of the table, relative changes in the base torque with respect to a column-specific change in the input torque over time can be described. In the cells, these relative changes in the base torque can be described for various cadences. The table can contain entries for a relative change in the base torque for discrete values of the change in the input torque and the cadence. Entries can also be equal to zero when there should not be a relative change in the base torque for the associated change in the input torque and the cadence. Entries can be positive and negative, as a result of which the base torque can be increased and decreased. The current base torque can be determined on the basis of the base torque from the preceding determination step and the relative change in the base torque determined from the table. A similarly designed table can describe the dependence of the base torque on the change in the cadence over time. The entries can behave inversely with respect to one another, according to the above-described inverse weightings. The relative changes in the base torque found in the two tables can be calculated together in order to obtain an overall relative change in the base torque. The dynamic function can have tables with modified values for the relative change in the base torque. Therefore, the base torque to be determined can be reached or obtained via filtering more quickly.

The method also includes controlling the electric motor with a target torque depending on the base torque. The target torque can be determined after the base torque has been determined and depending on the base torque. The target torque can be equal to the base torque. The target torque can represent the torque to be set by the electric motor, wherein this, together with the input torque from the rider, can represent the total torque. The total torque together with the cadence can represent the total power which can be used to propel the bicycle. After the determination of the base torque and prior to the control with the target torque, the base torque can be changed. In particular, the base torque can be changed prior to the determination of the target torque. Therefore, the target torque, which is determined depending on the modified base torque, can be used to control the electric motor. Alternatively or additionally, the determined target torque can be changed prior to the control of the electric motor.

Advantageously, therefore, a method for controlling an electric motor of an electric bicycle can be described, in which the control is carried out at different cadences with differently weighted dependencies on the changes in the input torque and the cadence over time. Therefore, a rider's intention with respect to the control of the electric motor can be better detected, the rider's intention being detectable only via the movement of the crank. The dependence of the base torque can be such that, at low cadences, there is a high dependence on the change in the input torque over time. At low cadences, the input torque can be relatively high due to a general power ratio between the cadence and the input torque. The general power ratio can describe the power applied by the rider, given by the cadence and the input torque at the crank, and can be constant over wide ranges of the cadence. Therefore, there can be a high input torque at low cadences, and there can be a lower input torque at higher cadences, which can result in nearly constant power. A change in the input torque can be better detected at high values of the input torque. Therefore, a change request from the rider due to an input torque changing over time can be better taken into account by the method at low cadences. At higher cadences, it can be advantageous that the dependence of the base torque on the change in the cadence over time increases as the cadence increases, since the cadence also increases in absolute values and a change in the cadence can be better detected and determined. Therefore, a change request from the rider at high cadences can be better detected via the changing cadence.

According to a further example embodiment, the base torque can be determined depending on a riding mode. The riding mode can be at least one of standstill, starting off, riding, acceleration, kickdown, rolling without motor assistance, and boost. The riding mode can be determined depending on a relative speed of the bicycle with respect to the ground. In different riding modes, the dependence of the base torque on the change in the input torque over time and on the change in the cadence over time can differ as a function of the cadence. Riding mode-specific tables based on the dependence between base torque and change in the input torque and the cadence over time can be provided for each riding mode. Functions which describe the weightings of the changes in the input torque and in the cadence with respect to the cadence can differ for various riding modes. For example, in the “starting off” riding mode, the base torque can depend more heavily on the change in the input torque over time than at the same cadence in the “acceleration” riding mode during the journey, i.e., with an existing relative speed of the bicycle with respect to the ground.

Advantageously, by the method, the weighting of the changes in the input torque and in the cadence over time can be shifted depending on the riding modes such that the rider's intention can be detected in any riding mode in the best way possible on the basis of the changes in the input torque and the cadence. Therefore, in the “starting off” riding mode, it can be more useful to weight the input torque more heavily at a low cadence, and, during acceleration while riding, it can be more useful to weight the change in the cadence, at an otherwise identical absolute cadence, more heavily in order to determine the base torque. Therefore, the rider's intention can be detected in the best way possible in any riding mode and, as a result, the electric motor can be optimally controlled according to the riding mode and the rider's intention.

According to a further example embodiment, the method can also include determining a crank position depending on the change in the input torque over time. The step of determining the crank position can be carried out depending on a time curve of the input torque. The time curve can be determined by values of the input torque, which have been recorded over time. For example, a sinusoidal function can describe the input torque as a function of time. In this case, in particular, a sine-squared function can describe the input torque as a function of time. The local maxima of the function can describe the two horizontal positions of the crank in the course of one complete revolution of the crank, since, in the presence of a force from the rider onto the pedal, which is assumed to be constant, the input torque is the maximum in these crank positions due to the maximum leverage.

Advantageously, the crank position can be determined by the determined change in the input torque over time even in cases in which the motor control unit has no information regarding the absolute crank position.

According to a further example embodiment, the determining the base torque can include correcting the input torque by the crank position. The crank position can be stored on a memory, which can be accessed by the motor control unit carrying out the method. Alternatively or additionally, the crank position can be determined in the determining the crank position. Due to the leverage between a bottom bracket of the crank and the pedal, which changes sinusoidally with one revolution of the crank, the input torque can also change. Alternatively or additionally, the input torque can change due to the changing action of force from the rider onto the pedal. In an angular position between 0°, wherein 0° describes the crank at its highest point, and 45°, no force or only minimal force can be applied to the pedal by the rider. The same applies for angular positions between 135° and 180°. In other words, the base torque can depend only on input torques at crank positions between 45° and 135°. The correcting can be carried out for input torques at a limit cadence, since, for example, a crank position still cannot be determined below the limit cadence.

Therefore, advantageously, the method can be designed such that only a subset of detected input torques, which describes the riding behavior and the change request, can be used to determine the base torque. Therefore, the base torque can be independent of values of the input torque which are recordable at a crank position and which cannot represent the actual input torque of the rider, for example, 0°-45° and, alternatively or additionally, 135°-180°. Therefore, the rider's intention can be exactly detectable and the control of the electric motor with the target torque can even better correspond to the actual rider's intention.

According to a further example embodiment, the method can also include adjusting the base torque depending on a riding mode. Adjusting can include increasing the determined base torque, holding the determined base torque constant, or decreasing the determined base torque. The riding mode can assume a certain mode depending on physical variables related to riding, such as, for example, a slope, a lateral acceleration, an inclination and, alternatively or additionally, the input torque. The riding mode can be a mode from an ECO mode, a tour mode, a trail mode, a user-specific mode, and an auto mode. For example, in the ECO mode, the base torque can be decreased and in a tour mode the base torque can be increased by the factor 2.5. The factor with which the base torque can be adjusted depending on the riding mode can be referred to as a gain factor. The riding mode can be predefined by the rider due to an active rider's intention via a user interface, for example, via a switch on the handlebar.

Advantageously, the base torque and thus the control of the electric motor with the target torque can be adjusted by a user request which has been actively predefined by the rider and via a user interface.

The adjustment of the base torque depending on the riding mode can be carried out, similarly to further adjusting the base torque depending on other variables, after the determining the base torque and prior to the determining the target torque depending on the base torque. The determination of the target torque can be carried out depending on the adjusted base torque. One or more adjusting of the base torque depending on various variables can be carried out independently of one another and in any order.

According to a further example embodiment, the method can also include adjusting the base torque depending on the cadence. The adjusting can be carried out depending on the cadence and regardless of the detected input torque. In other words, after determining the base torque depending on the changes in the input torque and the cadence over time, the determined base torque can be adjusted depending on the cadence. Adjusting can include increasing the determined base torque, holding the determined base torque constant, or decreasing the determined base torque. The adjustment of the base torque depending on the cadence can be carried out differently in different modes. For example, in a first mode, the base torque can be adjusted constantly over all cadences with a factor greater than 1 at a cadence not equal to 0, i.e., increased. In a second mode, the base torque can be increased more, with factors greater than 1 in a cadence-dependent manner, as cadences increase.

Advantageously, the absolute value of the cadence can therefore be weighted when the base torque is adjusted.

According to a further example embodiment, the method can also include adjusting the base torque depending on a speed of the bicycle. Adjusting can include increasing the determined base torque, holding the determined base torque constant, or decreasing the determined base torque. The adjustment of the base torque depending on the speed can be carried out differently in different modes. For example, in a first mode, the base torque can be increased constantly with a factor greater than 1 for all speeds not equal to 0. In a second mode, the base torque can be increased with a factor which increases with the speed. Alternatively or additionally, the method can also include adjusting the base torque depending on a riding resistance during the journey. The riding resistance can include an aerodynamic drag and, alternatively or additionally, a rolling frictional resistance.

Advantageously, the method can therefore adjust the base torque to resistance due to increasing rolling friction and air friction, which increase as the speed increases, and thus counteract the resistances.

According to a further example embodiment, the method can also include adjusting the base torque depending on a slope of a road surface. Adjusting can include increasing the determined base torque, holding the determined base torque constant, or decreasing the determined base torque. The base torque can have a continuously increasing factor greater than 1 for the adjustment as the slope of the road surface increases positively, i.e., when riding uphill. In the case of slopes which become smaller and are negative, i.e., when riding downhill, and a hill which becomes steeper and steeper, the base torque can be adjusted with a factor less than 1 and becoming smaller. In other words, when riding uphill and when riding uphill becomes steeper and steeper, the base torque can be increased more. When riding downhill and when riding downhill becomes steeper and steeper, the base torque can be reduced more and more. The adjusting the base torque depending on the slope can be carried out differently in different modes. In a first mode, the slope-dependent factors for adjusting the base torque can be a multiple of factors of a second mode. Therefore, the slope-related assistance can be carried out differently in different modes. The mode can be selected by the rider by active user input via a user interface.

Therefore, advantageously, by the method, the slope of the road surface can be addressed and the target torque, which has been adjusted according to the slope, can be determined and used to control the electric motor.

According to a further example embodiment, the method can also include adjusting the base torque depending on an inclination of the bicycle relative to the direction of the weight force. Adjusting can include increasing the determined base torque, holding the determined base torque constant, or decreasing the determined base torque. The inclination can be defined, for example, in positive values to the right and in negative values to the left. When negotiating a curve, the bicycle can have an inclination in one direction or in the other direction. For example, on an inclination which is increasing in absolute values, i.e., regardless of the direction of the inclination, the base torque can be adjusted with a factor less than 1, which decreases at the inclination increases, and thus reduced. Different factors can be used in different modes given the same inclination angles.

Advantageously, the method can therefore adjust the base torque when a curve is negotiated or in other riding states in which the bicycle can be inclined, and thus determine the target torque for controlling the electric motor. For example, when a curve is negotiated, a particularly strong acceleration can be omitted, such that the method can respond, on the basis of the control of the electric motor, to the lateral accelerations which occur when a curve is negotiated, with longitudinal accelerations which are reduced as compared to riding straight ahead. The wheels of the bicycle can therefore be prevented from breaking loose or slipping due to excessively high accelerations. Different factors can be used in different modes given the same inclination angles. More sporty riders, who can also handle greater assistance on strong inclinations, can select a mode in which the inclination-dependent factors for adjusting the base torque can result in higher values of the base torque.

According to a further example embodiment, prior to controlling the electric motor with the target torque, the target torque can be limited to a maximum value in a limiting. The maximum value can be stored on a memory and read out by the motor control unit which is carrying out the method. The maximum value can be absolute. The maximum value can include multiple individual maximum values, none of which is permitted to be exceeded. Alternatively or additionally, the maximum value can be relative, and therefore a maximum power, which is calculated from target torque and cadence, cannot be exceeded. Alternatively or additionally, the maximum value can depend on external variables, such as on the speed of the bicycle over ground, on the temperature or on external signals. External signals can be, for example, signals from traffic control systems such as traffic lights, and include information regarding a traffic flow, for example, green lights. The electric motor can therefore be controlled depending on the traffic situation. Alternatively or additionally, the electric motor can be controlled depending on the outside temperature, such that a temperature-dependent maximum output of the electric motor cannot be exceeded and thus permanent damage to the electric motor can be avoided. The dependence of the maximum value on the speed can be based on a legal requirement. The maximum value can be dependent on position data, such as GPS data. Therefore, range control can be implemented by the method. The maximum value can depend on data for accident avoidance. The maximum value can depend on information from another vehicle in the immediate surroundings, for example, for collision avoidance. Alternatively or additionally, the maximum value can depend on ABS data, such that the bicycle can remain capable of maneuvering. The maximum value can depend on the cadence. At a cadence equal to 0, the maximum value of the target torque can be specified as 0. By a user input, the rider can activate a walk-assist function on the bicycle, wherein the maximum value of the target torque is adjustable such that the electric motor can also be controlled at a cadence equal to 0 such that the bicycle can be accelerated up to a maximum speed of approximately 6 km/h.

As an alternative to or in addition to the limiting the target torque, the method can include increasing the target torque to a minimum value. For example, the increase can be carried out depending on health data of the rider. For example, the input power of the rider can be detected and the target torque can be increased such that a maximum power of the rider is not exceeded.

A further example aspect of the invention relates to a motor control unit. The motor control unit can be designed to carry out the method according to one example embodiment of the preceding example aspect of the invention for controlling an electric motor.

A further example aspect of the invention relates to a bicycle, which has an electric motor and a motor control unit according to the preceding example aspect of the invention. The bicycle can also have a crank, pedals, a battery, a user interface and/or a cable connection for connecting the battery, the user interface, the electric motor and the motor control unit.

### BRIEF DESCRIPTION OF THE FIGURES

FIG. 1 schematically shows steps of a method for controlling an electric motor according to one example embodiment.

FIG. 2 schematically shows the weighting of the dependencies for determining the base torque in the method for controlling an electric motor according to one example embodiment.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

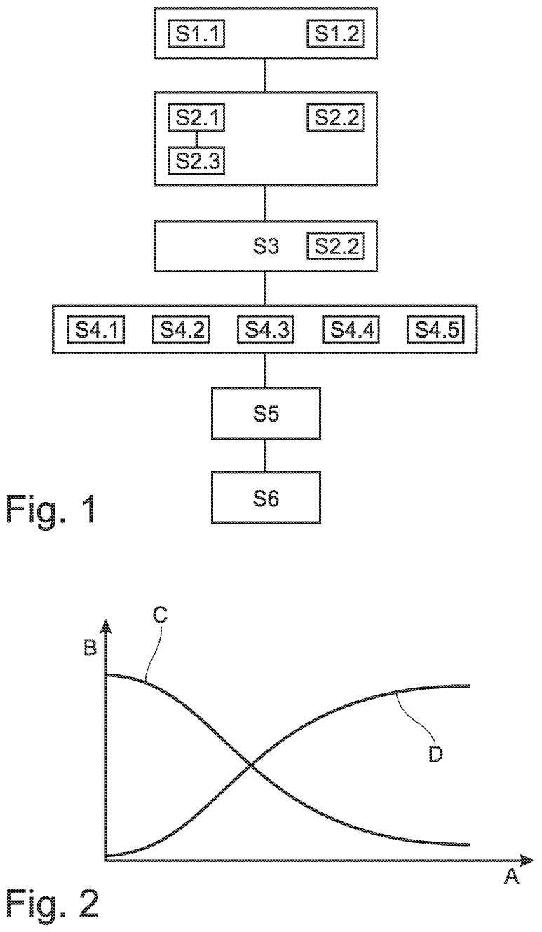

FIG. 1 schematically shows steps of a method for controlling an electric motor according to one example embodiment. The electric motor is part of an electric bicycle and the bicycle has a crank. The electric motor is connected to the crank. The bicycle includes a motor control unit for controlling the electric motor, the motor control unit being designed to carry out the method. The bicycle includes a torque sensor, which is mounted on the crank, for detecting S1.1 an input torque. The input torque is a torque applied to the crank by a rider of the bicycle. The sensor detects the input torque periodically and thus at multiple points in time. Another sensor of the bicycle detects the cadence of the crank. The detection S1.2 of the cadence of the crank is carried out periodically and thus for multiple points in time. The detection S1.1 of the input torque and the detection S1.2 of the cadence are carried out independently of one another.

The method includes determining S2.1 a change in the input torque over time. The determining S2.1 is carried out on the basis of the detected input torque at different points in time. The method includes determining S2.2 a change in the cadence over time. The determining S2.2 is carried out on the basis of the detected cadence at different points in time. The determining S2.1, S2.2 the changes in the input torque and the cadence over time are carried out independently of one another. The changes in the input torque and the cadence over time are relative changes of input torque and cadence with respect to previously detected values of input torque and cadence. A determining S2.3 a crank position is carried out depending on the determining S2.1 the change in the input torque over time. The determination of the crank position S2.3 is carried out depending on a time curve of the input torque. The time curve of the input torque depends on the determined change in the input torque over time.

The method includes determining S3 a base torque. The determining S3 the base torque is carried out depending on the change in the input torque over time and depending on the change in the cadence over time. FIG. 2 shows a weighting of the dependencies. The weightings of the dependencies are plotted along the y-axis B. The change in the input torque over time, curve C, and the change in the cadence over time, curve D, are plotted as a function of the cadence, shown on the x-axis A. The weightings determine the dependencies when determining S3 the base torque. At low cadences, the base torque heavily depends on the change in the input torque over time. This weighting decreases as cadences increase. Simultaneously, the weighting and thus the dependence of the base torque on the change in the cadence over time increase as the cadence increases. Since the product of cadence and torque yields the power, and the power, applied by the rider, is assumed to be nearly constant over large parts of the journey, it follows that the summed weightings of the changes in the input torque and the cadence over time are to be nearly constant over large parts of the cadence.

The method includes correcting S3.1 the input torque by the crank position. The correcting S3.1 is carried out during the determining S3 the base torque, such that the base torque, which is determined in the determining S3, is corrected by the crank position.

The method also includes adjusting S4.1 the base torque depending on the riding mode. The method also includes adjusting S4.2 the base torque depending on the cadence. The adjusting S4.2 can be carried out regardless of the detected input torque. The method also includes adjusting S4.3 the base torque depending on the speed of the bicycle. The method also includes adjusting S4.4 the base torque depending on the slope of the road surface. The method also includes adjusting S4.5 the base torque depending on the inclination of the bicycle relative to the direction of the weight force. The adjustings S4.1-S4.5 are carried out simultaneously, wherein each adjustment represents an individual factor of a product for adjusting the base torque. The adjustings S4.1-S4.5 are carried out independently of one another. In one example case, only a subset of the steps of adjusting S4.1-S4.5 can be carried out. After the last adjusting S4.1-S4.5, a target torque is determined depending on the determined and adjusted base torque.

The method also includes limiting S5 the target torque to a maximum value. The maximum value is an absolute value, e.g., in newton meters. The maximum value reflects the maximum value of the electric motor, which is limited by the structural type. By limiting S5 the target torque to the maximum value, a long-term use of the electric motor up to this maximum value can be ensured, without the possibility of damage occurring.

The method includes controlling S6 the electric motor with the limited target torque. The supply of the electric motor with electrical energy from a battery is controlled according to the target torque, such that the electric motor can provide the target torque.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

S1.1 (step) detecting an input torque
S1.2 (step) detecting a cadence of the crank
S2.1 (step) determining a change in the input torque over time
S2.2 (step) determining a change in the cadence over time
S2.3 (step) determining a crank position
S3 (step) determining a base torque
S3.1 (step) correcting the input torque by the crank position
S4.1 (step) adjusting the base torque depending on a riding mode
S4.2 (step) adjusting the base torque depending on the cadence
S4.3 (step) adjusting the base torque depending on a speed of the bicycle
S4.4 (step) adjusting the base torque depending on a slope of a road surface
S4.5 (step) adjusting the base torque depending on an inclination of the bicycle
S5 (step) limiting a target torque
S6 (step) controlling the electric motor with target torque depending on base torque
A cadence
B weighting of the dependencies
C change in the input torque over time
D change in the cadence over time

1-12: (canceled)

13. A method for controlling an electric motor of an electric bicycle, the electric bicycle including the electric motor and a crank, the method comprising:
detecting (S1.1) an input torque at two or more different points in time, the input torque corresponding to a torque applied to the crank by a rider of the bicycle;
detecting (S1.2) a cadence of the crank at two or more different points in time;
determining (S2.1) a change in the input torque over time based on the detected input torque at the two or more different points in time;
determining (S2.2) a change in the cadence over time based on the detected cadence at the two or more different points in time;
determining (S3) a base torque depending on the change in the input torque over time and on the change in the cadence over time, wherein, in determining (S3) the base torque, a dependence of the base torque on the change in the input torque over time decreases as the cadence increases, and wherein, in determining (S3) the base torque, a dependence of the base torque on the change in the cadence over time increases as the cadence increases; and
controlling (S6) the electric motor with a target torque depending on the base torque.

14. The method of claim 13, wherein determining (S3) the base torque comprises determining (S3) the base torque depending on a riding mode.

15. The method of claim 13, further comprising determining (S2.3) a crank position depending on the change in the input torque over time.

16. The method of claim 15, wherein determining (S3) the base torque comprises correcting (S3.1) the input torque based on the crank position.

17. The method of claim 13, further comprising adjusting (S4.1) the base torque depending on a riding mode.

18. The method of claim 13, further comprising adjusting (S4.2) the base torque depending on the cadence regardless of the input torque.

19. The method of claim 13, further comprising adjusting (S4.3) the base torque depending on a speed of the bicycle.

20. The method of claim 13, further comprising adjusting (S4.4) the base torque depending on a slope of a road surface.

21. The method of claim 13, further comprising adjusting (S4.5) the base torque depending on an inclination of the bicycle relative to a direction of a weight force.

22. The method of claim 13, further comprising, prior to controlling (S6) the electric motor with the target torque, limiting (S5) the target torque to a maximum value.

23. A motor control unit configured for implementing the method of claim 13 for controlling the electric motor.

24. A bicycle, comprising the electric motor and the motor control unit of claim 23.
